(19) United States
(12) Patent Application Publication
(10) Pub. No.: US 2006/0155854 A1
(43) Pub. Date: Jul. 13, 2006

(54) Setting user preferences via a mobile terminal

(76) Inventor: Franklin Selgert, Bl Berkel En Rodenrijs (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/538,570

(22) PCT Filed: Dec. 17, 2003
(86) PCT No.: PCT/EP03/14463

§ 371 Date: Jun. 15, 2005

(30) Foreign Application Priority Data
Dec. 23, 2002 (EP) 02080485.2

(51) Int. Cl. G06F 15/16

(52) U.S. Cl. 709/227

(57) ABSTRACT

Method, system and terminal for setting, in an information system comprising a network (2, 7) connecting user terminals (1) and one or more servers (4, 8, 9), local user preferences valid for the terminal and non-local user preferences valid for said one or more servers. A preferences setting file is downloaded from one of said servers to the relevant terminal, which is completed by the terminal user with the user's local and/or non-local preferences. Subsequently, the completed preferences setting file is uploaded to the relevant server (9). One or more preference groups (“moods”) may be assigned to the completed local and/or nonlocal preferences. The user may select one occurrence out of said preference groups, resulting in retrieval in the relevant server (9), the local and/or non-local preferences assigned to the selected preference group, and activating the relevant preferences in the terminal and the network and/or the one or more servers.

### FIELD OF THE INVENTION

The invention refers to the setting of user preferences, listed in a user terminal or in an information or transmission system to which a user terminal may be connected.

### BACKGROUND OF THE INVENTION

There are a variety of terminals that can be configured or programmed to the personal preferences and needs of a user.

For example a computer with a graphical user interface can be personalized by setting a background picture, customizing color schemes, customizing event sounds and setting software specific features like the accessibility of menus and functionality. When the computer is used for communication, e.g. for email, chatting or IP telephony, a user can be given the possibility to program events like pop-up screens appearing when messages arrives or blocking incoming/outgoing messages based on a criteria.

Another example of such a terminal is a mobile phone, which can be configured through a menu. By pressing the menu button on the mobile phone a user gets the possibility to change settings related to the phone itself, change security settings, change network settings, and select or modify profiles. Examples of settings related to the phone itself are selecting the language of the user-interface, adjusting the contrast of the display and adjusting the appearance of the build-in clock. Security settings are related to pin-codes, which can be set and changed by the user. The network settings are used to set the behavior of the mobile phone in the network. For example the user can choose whether the mobile phone automatically selects a network based on the strength of received communication signals or a manual selection is to be made by the user when the network changes. Profiles are used to make many changes in the mobile phone at once. Examples of profiles are “normal surroundings”, “silent surroundings”, “meeting” and “car”. By selecting a profile the ring tone, ring tone volume, vibration and settings related to the phone itself are selected at once. The user can modify the settings in the profile.

Besides configuring and programming terminals it is also possible to let a user make changes in the network the terminal is connected to. For example a user with a mobile phone can change redirection settings by calling a specific number or using a shortcut in the mobile phone, making all incoming calls being forwarded to another terminal. Another example is the (de) activation of a voicemail box, which is located in the network and can be used by a calling party to leave a message when the user does not answer the phone.

It can be important to technically detect the status of a terminal user at a certain moment and/or location. It is undesirable for example that a mobile terminal receives and displays an advertisement (which can be pushed to the terminal, i.e. sent to the terminal without the user requesting it) about e.g. a special offer of snacks when the user attends a business meeting or has a romantic date. In general the fact that the user's current situation (or mode, mood or environment) cannot be technically detected by the sending party or the network, is seen as an important obstruction for the success of pushed content delivery. Although users already become used to set their terminal to a number of profiles, those profile settings are local terminal settings that are not detectable by the sending party or network.

### SUMMARY OF THE INVENTION

One aspect of the present invention is to enable the terminal to set both local user preferences valid for the terminal itself and non-local user preferences, valid for one of more servers.

Another aspect is to apply one common user interface and/or platform for the setting of user preferences, valid for the terminal and/or the network and/or external servers.

A further aspect is to load a “user preferences setting page” or the like (e.g. by means of WAP, I-mode, etc.) from an Internet server, comprising input fields which can be used by the user to input the desired preferences in the telecommunications and/or data network. Via the same Internet page local terminal settings may be set, e.g. using an “Application Program Interface” (API) linked to the terminal's control software.

The user may use the “user preferences setting page” for setting, resetting or amending the user's preferences, e.g. adapted to the user's “mode”, “mood” or “environment”. By selecting the desired right “mood”, the behavior of the terminal, viz. the terminal itself and the information to be supplied to the user, will be applied, both within the terminal and outside the terminal, viz. by the relevant server(s).

The “user preferences setting page”—which will also called “mood page” hereinafter—thus may be used to set e.g. a “buy mode”, business mode”, “holidays mode”, “romantic mode”, etc. Each mode may comprise a group (cluster) of setting parameters, some of which relate to the terminal itself, e.g. the ring tone mode, and some of them relate to the form and/or content of information, which may or may not be sent to the terminal. Also network settings (parameters) may be incorporated in said groups.

The “mood page” preferable has the form of a “portal”, serving as a interchange page via which various other information services may be called and/or routed to deliver their content to the relevant user terminal.

### FIGURES

FIG. 1 shows schematically the Internet and a mobile telecommunication network, as well as a mobile terminal.

FIG. 2 shows schematically an embodiment of a mobile terminal, which is enabled to cooperate with the telecommunication network and the Internet.

### DETAILED DESCRIPTION

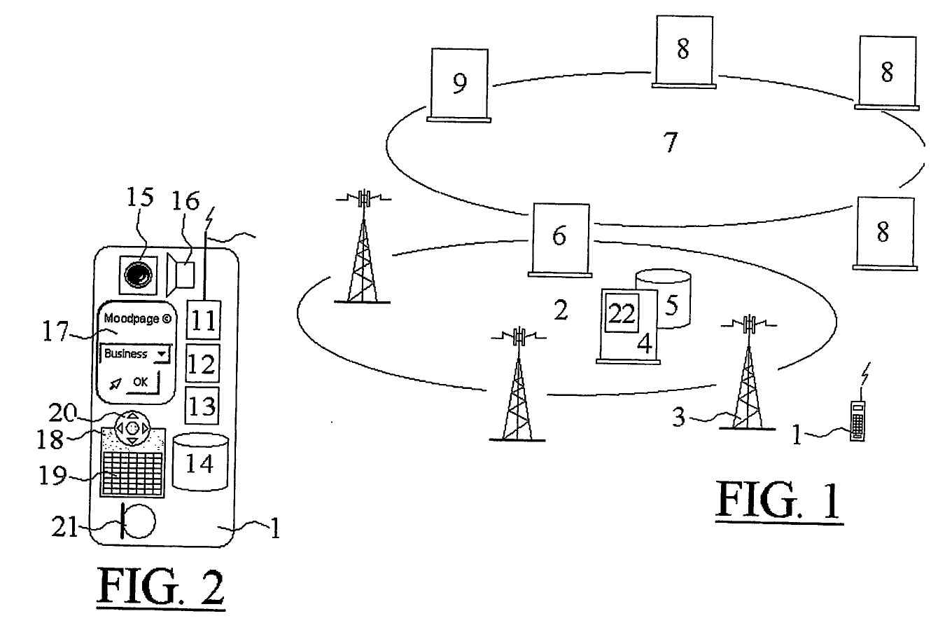

In FIG. 1 a terminal 1 may be connected to a telecommunication network 2, via base stations 3. The network 2 is controlled by control means 4, including a database 5. The control means 4 can comprise a plurality of servers, exchanges, registers and/or databases. The control means can be based on “Intelligent Network” (IN) technology, which is fit for lean and mean adaptation of user preferences, which may be registered in the relevant database(s).

By means of a telephony or Internet interface server 6, e.g. known from applicant's EP2079379, the telecommunication network 2 is linked with the Internet (“world wide web”) 7 or any other data network. Connected to the Internet 7 are several servers 8 which may be enabled to deliver information in the form of graphics, text, images, sound or video. One server 9 can optionally serve as “portal” for services to and from mobile terminals like terminal 1.

FIG. 2 shows schematically the architecture of terminal 1 more in detail. Shown is an antenna 10, connected to a transceiver 11, which, in turn, is connected with a terminal controller 12. Controller 12 is connected with an API module 13, a register 14, a camera 15, a loudspeaker 16, a video display screen 17, an input module 18, comprising a keyboard 19 and a pointing device 20, and a microphone 21. For sake of clarity, the interconnections between the various modules are not shown in FIG. 2. The example of FIG. 2 shows a mobile phone. It is also possible to use other kind of terminals, like PDA's, organizers and mobile computers, as long as they are equipped with communication means.

The terminal 1 may originate a call to another terminal via the network 2. Such a call may be setup by means of the keyboard 19, the controller 12, the transceiver 11, the antenna 10, one of the base stations 3 and the network control means 4, which will setup a connection to the relevant called terminal. A call from another terminal to terminal 1, will arrive at the control means 4 in the same way, after which the control means 4 will setup a connection to terminal 1 via the relevant base station 3, guided by e.g. location information of terminal 1 registered in database S. The received call will reach controller 12 via the antenna 10 and transceiver 11, resulting in e.g. outputting a call tone via the loudspeaker 16, whereupon the terminal user may pick up the call by pushing the relevant button on the keyboard 19.

When a user is e.g. attending a meeting, the user may have set locally—e.g. via keyboard 19—the terminal's call tone into “buzz” mode, or the user, in another environment, may set a certain preferred ring tone, for instance some measures of the user's favorite piece of music. Besides to make a voice connection with another terminal, terminal 1 may be enabled to communicate with Internet servers 8. To that end the terminal 1 may connect, via interface 6, the relevant portal server 9. Via portal 9 information (text, graphics, video, sound, etc.) may be downloaded from (and/or uploaded to) one or more of the servers 8. Said information is transmitted to the terminal 1 and presented to the terminal's display 17 and/or—in the case of audible information—the loudspeaker 16.

Besides setting preferences within the terminal, as discussed before, the user may set user preferences within the telecommunication network 2, which settings may be registered in database 5, and/or user preferences in the Internet domain (e.g. preferences in the portal 9 and/or within (files within) one or more servers 8).

The user preferences can be set using one common (e.g. graphic) user interface, residing in the terminal 1, to set both the local terminal related preferences like e.g. ring tone settings and external settings, registered in the telecommunication network and/or in the internet. To that end the terminal 1 comprises an API (Application Program Interface) or equivalent module 13. In general an API is a software module comprising a language and message format used by an application program to communicate with the operating system or some other control program such as a database management system or communications protocol. API's may be implemented by writing function calls in the program, which provide the linkage to the required subroutine for execution. Thus, an API implies that some program module is available in the computer to perform the operation or that it must be linked into the existing program to perform the tasks.

Being connected to the Internet portal server 9, the terminal 1 may load a common setting internet page (“preferences setting page”) which may be displayed at the screen 17 and which includes fields which may be filled by the user with the user's preference parameters, clustered together to different “moods”, “modes” or “environments” (hereinafter to be called “moods”). The parameters may partly apply to local terminal settings relating to the terminal hardware and/or software to be registered in the terminal's register 14. The parameters may also partly apply to settings for the telecommunication network 2, to be registered in database 5. And finally, part of the user preference setting may apply to one or more Internet servers, either having the function of portal, like server 9, or not, like the servers 8.

For instance, user preference parameters for the mood “business” could comprise e.g.:

One or more terminal parameters e.g. setting the terminal's ring tone to buzz or vibrate, to be registered into terminal register 14;

One or more network parameters e.g. setting the network 2, to be registered into the network control database 5, e.g. setting that only one or some restricted originating callers may access the user's terminal 1, while all remaining callers are rerouted to e.g. a secretary's telephone number or to the user's voice mail box;

One or more portal server parameters, to be registered into the portal server, e.g. setting a preference relating to the format (font, background) of Internet pages to be displayed to the user via the terminal screen 17;

One or more content provider parameters, to be registered within the portal server 9 and/or the relevant content servers 8, e.g. setting the content to be downloaded to the terminal 1, e.g. relevant stock quotes or selected business news.

All those parameters are to be input in said “preferences setting page”, in this example related (and clustered) to the “business mood”. The same page may comprise input fields in which preferences are related to other moods, like “home”, “holiday”, “hobby” etc. All those clustered preferences may be input by means of one “preferences setting page” common for all “moods” or via separate “preferences setting pages” per “mood”.

All parameters are thus recorded via the “preferences setting page(s)” and transmitted to the portal server 9, in which the all those parameters are registered.

When the terminal user, after having transmitted his/her preferences for the various moods to the portal server 9, the user may load and activate his/her preferences by calling a “mood page” at the portal 9 and selecting or setting his/her mood for that moment, e.g. the mood “business”.

After the user selects and submits the mood “business” to the portal server 9, the portal server 9 retrieves the user's preference parameters from the relevant “preferences setting page(s)” and activates the relevant internet related parameters within the portal 9 and the relevant linked servers 8. The parameters which are valid outside the Internet domain, e.g. in the telecommunication network 2 and/or within the terminal 1 itself are sent back to the terminal 1 and set in its controller 12 via the API module 13, which is able to read and interpret the contents—especially the parameters—of the non-internet preferences sent back from the portal 9, to Interact with the controller 12 and to set the terminal settings like e.g. the ring tone settings etc. Besides, the API module 13 may output via controller 12 settings for the telecommunication network. Those network settings—which normally have to be set by the user by inputting such settings e.g. via the keyboard 19—will be forwarded, by the controller 12, to the network control means 4, to be registered in the relevant network database 5.

Registering and clustering—via completing the electronic form called “preferences setting page(s)”—of various “mood” related local (terminal) and non-local (network and/or server) settings enables the terminal user to adapt his/her terminal, network and server preferences to his/her mood, mode or environment in a trice, e.g. by selecting the relevant mood (cluster) and submitting it to the portal 9, which portal 9 subsequently retrieves all previously input parameters assigned to the selected mood. The parameters are used to adapt the portal's and the relevant server's settings to the user's “mood” and—after sending back the relevant parameters to the terminal 1—to set, via the terminal controller 12 the settings of the terminal 1 and/or the network 2.

It is noted that, to prevent the necessity to send back local and network parameters from the portal to the terminal and/or network, it may be advantageous to register those parameter within the terminal 1 and network 2 respectively instead of in the portal server 9. To that end the local and network parameters are read from the “preferences setting page” form(s) when the user completes them. When all preference parameters are filled in, the form is to be submitted to the portal 9. The API module 13 may be programmed thus that, on submission of the parameters by means of such a “preferences setting page” form, the API 13 intercepts the submitted parameters and registers locally, in register 14, the terminal and/or network parameters, labeled with (clustered to) the relevant mood item (e.g. “business”). To act in the desired way when, later on, the user decides to activate another mood, the API module 13 is programmed so that, when the user submits, by means the “mood page” called from the portal 9 e.g. the (new) mood “business”, The API 13 intercepts that new mood item (viz. “business”) and retrieves locally, in the register 14, the local and network parameters assigned to the label “business”. The terminal activates the locally registered parameters, while the Internet related parameters are retrieved by portal 9, which also activates those parameters. As the terminal and network parameters already are present in the terminal 1 it will be no longer necessary to send those parameters back to the terminal.

For completeness it is noted that it might be preferred to have an (additional) API module 22 within the network control means 4, enabling the control means 4 to intercept, register and afterwards retrieve in database 5 parameters which are valid for the user related preferred network settings, related to the various user moods like “business” etc. In that case the terminal 1 could intercept, register and retrieve locally the relevant terminal parameters using register 14 and API module 13, the network control means 4 could intercept, register and retrieve the relevant network parameters using database 5 and said API module 22, while only the internet related parameters should be registered and retrieved in the portal server 9 and/or content servers 8.

It is noted that the preference setting pages or mood pages might also be called and completed by means of e.g. a data terminal or computer connected to the internet 7, bypassing the relevant mobile terminal 1. The relevant mood pages can be secured against unauthorized access. Further, some mood page parameters could relate to billing aspects, e.g. billing accounts: by selecting “business” as mood the usage of the terminal, telecommunication network 2 and/or the internet related services of the servers 8 and/or 9 could be billed using a business account, while when the user selects a private mood like “holiday” the costs for using the terminal, telecommunication network and/or internet related services could be attributed to a private user account.

1. User terminal comprising control means (12), a user interface (17,18) and means for interaction between the terminal and one or more servers (4,8,9) via a network (2,7), the terminal comprising means (12,13), cooperating with the user interface, for both setting local user preferences valid for the terminal itself and non-local user preferences, valid for said one of more servers (4,8,9).

2. User terminal according to claim 1 in which said means are fit for
downloading and displaying a preferences setting file from one of said servers, which is to be completed via said user interface by the user with the user's local and/or non-local preferences,
and for uploading said preferences setting file completed with said local and/or non-local preferences to the relevant server (9).

3. User terminal according to claim 2 in which said means are fit for assigning one or more preference groups to the completed with local and/or non-local preferences.

4. User terminal according to claim 3 in which said means are fit
for selecting, via the user interface, one occurrence out of said preference groups,
for retrieving, in the relevant server (9), the local and/or non-local preferences assigned to the selected preference group,
and for activating the relevant preferences in the terminal and the network and/or the one or more servers.

5. User terminal according to claim 4, comprising an Application Program Interface (13) fit for activating the preferences in the terminal.

6. User terminal according to claim 4, comprising an Application Program Interface (13) fit for remotely activating the preferences in the network (2).

7. Information system, comprising
a network (2,7) connecting user terminals (1) and one or more servers (4,8,9), one or more of said the terminals and one or more of said servers comprising means for mutual interaction via a network (2,7),
and means for both setting local user preferences valid for the terminal itself and non-local user preferences, valid for said one or more servers.

8. Information system according to claim 7 in which said means are fit
for downloading a preferences setting file from one of said servers to the terminal,
for completing the preferences setting file with input from the user via a user interface with the user's local and/or non-local preferences,
and fit for uploading said preferences setting file completed with said local and/or non-local preferences to the relevant server (9).

9. Information system according to claim 8 in which said means are fit for assigning one or more preference groups to the completed local and/or non-local preferences.

10. Information system according to claim 9 in which said means are fit for selecting, by the user via the user interface, one occurrence out of said preference groups,
for retrieving, in the relevant server (9), the local and/or non-local preferences assigned to the selected preference group,
and for activating the relevant preferences in the terminal and the network and/or the one or more servers.

11. Information system according to claim 10 in which the terminal comprises an Application Program Interface (13) fit for activating the preferences in the terminal.

12. Information system according to claim 10 in which the relevant network comprises an Application Program Interface (22) fit for activating the preferences in the network.

13. Method for setting, in an information system comprising a network (2,7) connecting user terminals (1) and one or more servers (4,8,9), both local user preferences valid for the terminal and non-local user preferences valid for said one or more servers, comprising steps of
downloading a preferences setting file from one of said servers to the relevant terminal,
completing the preferences setting file with input from the terminal's user via a user interface with the user's local and/or non-local preferences, assigning one or more preference groups to the completed local and/or non-local preferences,
uploading said preferences setting file completed with said local and/or non-local preferences to the relevant server (9),
selecting, by the user via the user interface, one occurrence out of said preference groups,
retrieving, in the relevant server (9), the local and/or non-local preferences assigned to the selected preference group,
activating the relevant preferences in the terminal and the network and/or the one or more servers.
